(19) United States
(12) Patent Application Publication
(10) Pub. No.: US 2017/0169200 A1
(43) Pub. Date: Jun. 15, 2017

(54) METHOD AND APPARATUS FOR UNLOCKING THE LOCKED STATE OF A LOST MOBILE TERMINAL

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Tiancheng TONG, Beijing (CN)

(21) Appl. No.: 15/242,446

(22) Filed: Aug. 19, 2016

Related U.S. Application Data
(63) Continuation of application No. PCT/CN2016/089251, filed on Jul. 7, 2016.

(30) Foreign Application Priority Data
Dec. 14, 2015 (CN) 201510925747.2

(51) Int. Cl. G06F 21/31; G06F 3/0484; G06F 3/0488

(52) U.S. Cl. CPC G06F 21/31; G06F 3/04883; G06F 3/0484

(57) ABSTRACT

The present disclosure provides a method and electronic device for unlocking a mobile terminal in a loss lock state. The method includes: creating a wifi open button on a home page of the mobile terminal in the loss lock state; receiving a triggering instruction of a user for the wifi open button and opening a wifi setting page; establishing a network connection according to setting Information inputted by the user on the wifi setting page; receiving an unlocking password inputted by the user and uploading the unlocking password to a server for verification through wifi; and unlocking the mobile terminal in the loss lock state, if the verification is successful. With the disclosure, after the mobile terminal is locked and the data is cleared, the user can directly configure a wifi network and unlock the locked mobile terminal using the wifi network when no Sim card exits in the mobile terminal or a mobile data network of the Sim card is unavailable, so that the user can unlock the mobile terminal simply and quickly.

### CROSS-REFERENCE TO RELATED APPLICATION

This application is a continuation of International PCT Patent Application No. PCT/CN2016/089251, filed Jul. 7, 2016 (attached hereto as an Appendix), and claims benefit/priority of Chinese patent application No. 201510925747.2, filed with the State Intellectual Property Office of China on Dec. 14, 2012, which are all incorporated herein by reference in entirety.

### TECHNICAL FIELD

The present disclosure relates to the field of mobile communications, and in particular, to a method and electronic device for unlocking a mobile terminal in a loss lock state.

### BACKGROUND

With the continuous development and progress of society, mobile terminals such as mobile phone, tablet computer are increasingly common, and also play an increasingly important role in life. In various functions of the mobile terminal, a function of finding and remotely controlling a lost mobile terminal is absolutely an important and very useful function. If the mobile terminal is lost, the lost mobile terminal may be locked remotely with the above-described function, to make the mobile terminal enter a loss lock state. Only an operation of inputting an unlocking password can be performed on the mobile terminal in the loss lock state, other operations cannot be performed. Further, in order to prevent the leakage of data stored in the mobile terminal, an instruction may be sent remotely to make the mobile terminal perform an operation of clearing the data. After performing the operation of clearing the data, the mobile terminal can restart and enter a home page of the mobile terminal in the loss lock state. On the home page, the user only inputs the unlocking password, and cannot perform other operations.

After finding the mobile terminal in the loss lock state, the user can input the unlocking password on the home page to unlock the mobile terminal. The unlocking password is generally stored in a network server. In other words, the mobile terminal is required to be connected to the server via the network to verify the password in unlocking. If the data in the mobile terminal has been cleared, connected wifi information saved is also cleared, that is, the mobile terminal cannot be automatically connected to a previously used wifi. A Sim card of the mobile terminal is required to be set accordingly to turn on a mobile data Internet access function. But these specific operations are not supported by the mobile terminal in the loss lock state. In the above case, the mobile terminal in the loss lock state cannot be unlocked.

### SUMMARY

In view of above, an objective of the disclosure is to provide a method and electronic device for unlocking a mobile terminal in a loss lock state, so that the user can unlock the mobile terminal in the loss lock state rapidly, simply and effectively.

Based on the above objective, according to a first ascept of the disclosure, there is provided a method for unlocking a mobile terminal in a loss lock state, which includes:

creating a wifi open button on a home page of the mobile terminal in the loss lock state;

receiving a triggering instruction of a user for the wifi open button and opening a wifi setting page;

establishing a network connection according to setting Information inputted by the user on the wifi setting page;

receiving an unlocking password inputted by the user and uploading the unlocking password to a server for verification through wifi; and

unlocking the mobile terminal in the loss lock state, if the verification is successful.

According to a second aspect of the present disclosure, there is provided a computer storage medium which is stored with computer executable instructions, and the computer executable instructions are configured for performing any one of the above methods for unlocking a mobile terminal in a loss lock state.

According to a third aspect of the present disclosure, there is provided an electronic device including one or more processors and a memory, wherein, the memory is stored with instructions executable by the one or more processors, and the instructions are set to perform any one of the above methods for unlocking a mobile terminal in a loss lock state.

As can be seen from the foregoing description, in the method and electronic device for unlocking a mobile terminal in a loss lock state according to the disclosure, the user can call and open the wifi setting page under the loss lock state after finding the lost mobile terminal by creating a wifi open button on the home page of the mobile terminal in the loss lock state, and establishes a network connection by selecting an available wifi and unlocks the mobile terminal in the loss lock state. The whole process is simple and quick. Therefore, the user can unlock the mobile terminal in the loss lock state efficiently and effectively.

It should be understood that both the foregoing general description and the following detailed description are exemplary and explanatory only, and are not restrictive of the disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for unlocking a mobile terminal in a loss lock state according to an embodiment of the present disclosure;

FIG. 2 is a schematic diagram of a home page of a mobile terminal in a loss lock state according to an embodiment of the present disclosure;

FIG. 3 is a flow chart of a method for unlocking a mobile terminal in a loss lock state according to another embodiment of the present disclosure;

FIG. 4 is a schematic structural diagram of an apparatus for unlocking a mobile terminal in a loss lock state according to an embodiment of the present disclosure;

FIG. 5 is a schematic structure diagram of hardware of an electronic device according to an embodiment of the present disclosure.

### DESCRIPTION OF THE EMBODIMENTS

In order to make the objects, technical solutions and advantages of the present disclosure more clear and apparent, the present disclosure is described in details in conjunction with the embodiments and the drawings.

It should be noted that, all expressions of “first” and “second” used in embodiments of the disclosure are used to distinguish two different entities or parameters of the same name. Therefore, the “first” and “second” are merely convenient for expression, and should not be construed as limiting the embodiments of the disclosure, which are not illustrated any more in the following embodiments.

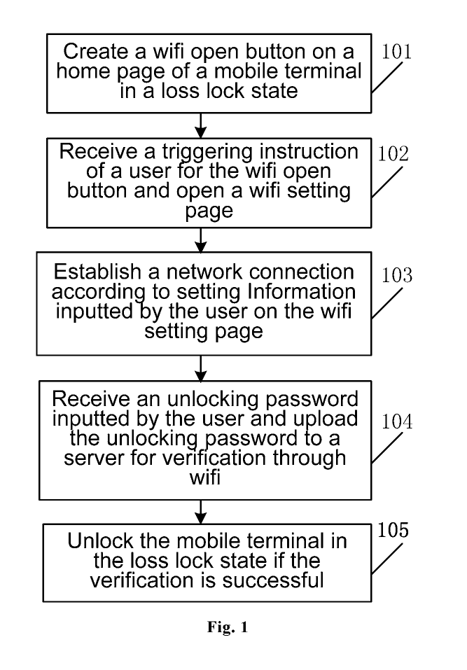

A method for unlocking a mobile terminal in a loss lock state is provided according to an embodiment of the disclosure. FIG. 1 is a flow chart of a method for unlocking a mobile terminal in a loss lock state according to an embodiment of the present disclosure.

The method for unlocking a mobile terminal in a loss lock state includes the following steps S101 to S105.

In step 101, a wifi open button is created on a home page of the mobile terminal in the loss lock state.

Based on the existing loss lock technology, after the user realizes that the mobile terminal is lost, the user can log in to a loss recovery service web site, and remotely send a locking instruction and a clearing data instruction to the mobile terminal. After receiving the locking instruction, the mobile terminal can call a locking module (SystemUI) to lock the mobile terminal to be in the loss lock state. After receiving the clearing data instruction, the mobile terminal performs a clearing data operation to clear user's data in the mobile phone including data of SD card and wifi connection information. After completing the clearing data operation, the mobile terminal automatically restarts, reads a lock_state of privacy partition, enters and continuously maintains the loss lock state, and remains on the home page of the mobile terminal in the loss lock state (later referred to as “home page”). Then, the mobile terminal creates the wifi open button on the home page.

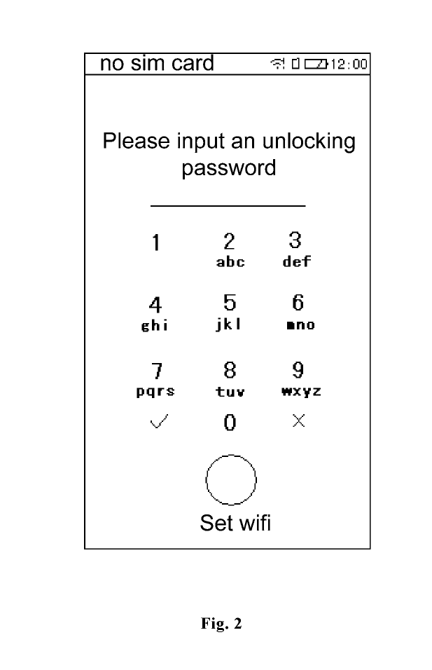

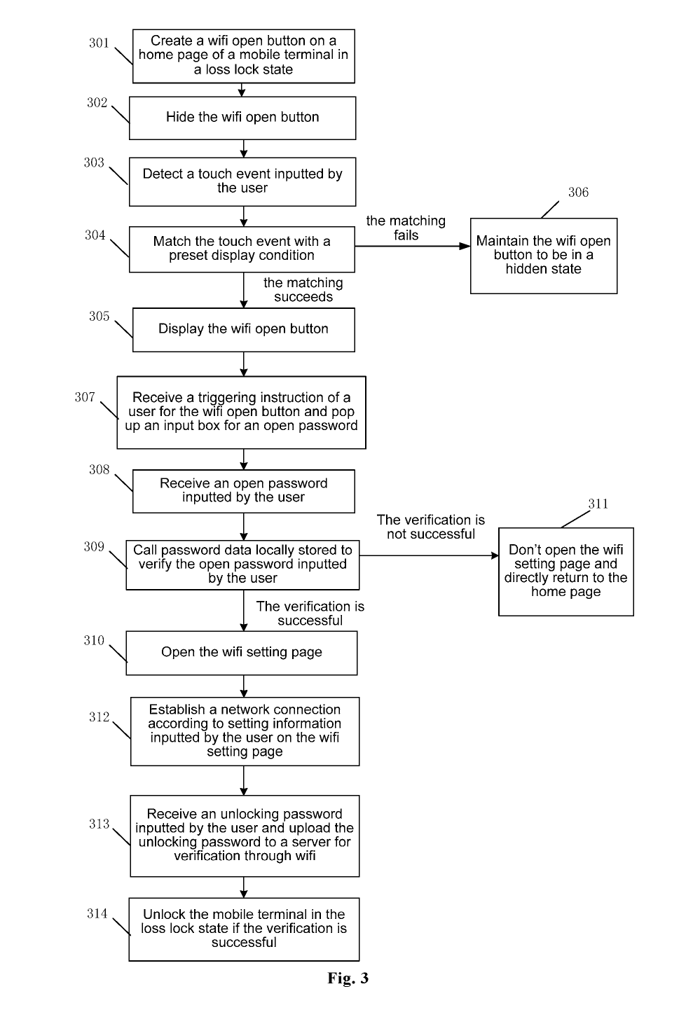

The wifi open button may be designed in circular, square, triangle or other geometric patterns, and be combined with a prompt text similar to “setting wifi” and the like, to prompt the user to operate the wifi open button. The display position of the wifi open button may be set flexibly according to requirement, and generally may be set in a digital input keyboard on the home page. For the display effect of the wifi open button, reference is made to a schematic diagram of the home page of the mobile terminal in the loss lock state as shown in FIG. 2.

In step 102, a triggering instruction of a user for the wifi open button is received and a wifi setting page is opened.

The user inputs a triggering instruction of the wifi open button. After the triggering instruction is received, the wifi setting page is opened. A list of all connectable wifi access points is present for the user to perform selection and accessing on the wifi setting page.

In step 103, a network connection is established according to setting information inputted by the user on the wifi setting page.

The user can select an available wifi access point from the list of wifi access points, and then input setting information such as a user name and a password into a popup input box on the wifi setting page. In a case that the verification of the setting information is successful, the network connection is established through the above wifi. After the network connection is established, it is returned to the home page again.

In step 104, an unlocking password inputted by the user is received and the unlocking password is uploaded to a server for verification through wifi.

The user can input the unlocking password via a digital keyboard on the home page. After the unlocking password inputted by the user is received, the unlocking password is sent to an unlocking server via the network connection established previously through the wifi. The unlocking server verifies the validity of the unlocking password inputted by the user, in other words, compares the unlocking password inputted by the user with a verification password pre-stored in the unlocking server.

In step 105, the mobile terminal in the loss lock state is unlocked, if the verification is successful.

If the unlocking password inputted by the user is identical to the verification password in the unlocking server, the verification is successful, and the unlocking server returns a verification pass instruction to the mobile terminal. According to the verification pass instruction, the mobile terminal in the loss lock state is unlocked. If the unlocking password inputted by the user is not identical to the verification password in the unlocking server, the verification is not successful, and the unlocking server returns a verification failure instruction to the mobile terminal. According to the verification pass instruction, the mobile terminal remains in the loss lock state.

As can be seen from the above embodiment, with the method for unlocking a mobile terminal in a loss lock state according to the disclosure, the user may create the wifi open button on the home page of the mobile terminal in the loss lock state, and the user can call and open the wifi setting page under the loss lock state after finding the lost mobile terminal, establishes a network connection by selecting an available wifi, and unlocks the mobile terminal in the loss lock state. This whole process is simple and quick. Therefore, the user can unlock the mobile terminal in the loss lock state efficiently and effectively.

As another more specific embodiment, FIG. 2 is a flow chart of a method for unlocking a mobile terminal in a loss lock state according to another embodiment of the present disclosure.

The method for unlocking a mobile terminal in a loss lock state according to the embodiment includes the following steps S301 to S314.

In step 301, a wifi open button is created on a home page of the mobile terminal in the loss lock state.

In step 302, the wifi open button is hidden.

In order to prevent a thief or a picker from connecting the wifi casually, the wifi open button is hidden in this step. The wifi open button is displayed only when the user inputs a specific touch event in a subsequent step. In other words, only the owner can enter the wifi setting page through the wifi open button in the loss lock state by setting a certain display condition.

In step 303, a touch event inputted by the user is detected.

In step 304, the touch event is matched with a preset display condition; step 305 is performed, if the matching is successful; or step 306 is performed, if the matching fails.

The above-described two steps are steps of matching the touch event inputted by the user and the display condition.

Specifically, the display condition may be set to be a preset sliding trajectory.

In detecting, a sliding touch event inputted by the user is detected and a sliding trajectory of the sliding touch event is recorded. In matching, it is determined whether the sliding trajectory is identical to the preset sliding trajectory. If the sliding trajectory is identical to the preset sliding trajectory, it is determined that the matching succeeds; or if the sliding trajectory is not identical to the preset sliding trajectory, it is determined that the matching fails.

The above-described “the sliding trajectory is identical to the preset sliding trajectory” does not mean the same in an absolute sense, but it is determined whether the sliding trajectory is sufficiently similar to the preset sliding trajectory. An optional way of determining whether the sliding trajectory is sufficiently similar to the preset sliding trajectory includes: presetting a similarity threshold; calculating a similarity between the sliding trajectory inputted by the user and the preset sliding trajectory through comparative analysis; and if the similarity resulted reaches the similarity threshold, it is determined that the sliding trajectory is sufficiently similar to the preset sliding trajectory, and it is determined that the matching succeeds; otherwise, it is determined that the matching fails.

Optionally, the display condition may also be set as a preset duration of heavy press or light press.

In detecting, a heavy press or light press touch event inputted by the user is detected and a duration of the heavy press or light press touch event is recorded. In matching, it is determined whether the duration is greater than or equal to the preset duration. If the duration is greater than or equal to the preset duration, it is determined that the matching succeeds. If the duration is less than the preset duration, it is determined that the matching fails.

The heavy press or light press means that the finger touches a touch screen of the mobile terminal and applies some pressure. A smaller pressure corresponds to the light press, and a larger pressure corresponds to the heavy press. An optional way of distinguishing the sizes of pressures corresponding to the heavy press and the light press may be the following ways.

A touch pressure is measured and the touch pressure is compared with a preset first pressure threshold by using a touch screen having a pressure measurement function to determine whether the touch event is the heavy press or the light press. In other words, if the touch pressure is greater than the first pressure threshold, it is determined that the touch event is the heavy press; or if the touch pressure is less than or equal to the first pressure threshold, it is determined that the touch event is the light press.

Optionally, a touch area is monitored by using a touch screen which can measure the touch area (the touch area is monitored with respect to a finger herein). During a first touch event, if a touch area of the finger on the touch screen is less than or equal to a first touch area threshold, it is determined that the touch event is the light press. During a second touch event, if a touch area of the finger on the touch screen is greater than the first touch area threshold, it is determined that the touch event is the heavy press.

Optionally, the pressure and the touch area may also be combined to determine that the touch event is whether the heavy press or the light press. For example, if the touch pressure is less than or equal to the first pressure threshold and/or the touch area of the finger on the touch screen is less than or equal to the first touch area threshold, it is determined that the touch event is the light press. If the touch pressure is greater than the first pressure threshold and/or the touch area of the finger on the touch screen is greater than the first touch area threshold, it is determined that the touch event is the heavy press.

The above way of distinguishing the heavy press and the light press may also be completed through an existing terminal with the 3D-touch technology, for example, an operating system IOS9.0 and above, an intelligent electronic device such as iPhone 6S, iPhone 6S plus, iPad pro and the follow-up products.

In step 305, the wifi open button is displayed on the home page.

In step 306, the wifi open button is maintained to be in a hidden state.

In step 307, a triggering instruction of a user for the wifi open button is received and an input box for an open password is popped up.

To further enhance security, when the user operates the wifi open button, a password verification process is required to be performed again. Specifically, the user can preset one open password in local, generate password data and store the password data into a storage firmware of the mobile terminal such that the password data can be called in verification. The open password is only used to trigger and open the wifi setting page, which should be different from the unlocking password for unlocking the mobile terminal in the loss lock state. Preferably, a format of the open password is set to be different from that of the unlocking password, such as different lengths and/or different password character limit. For example, the unlocking password is limited to be a combination of any six characters, and the open password is limited to be a combination of four numbers.

In step 308, the open password inputted by the user is received.

Through the pop-up input box for the open password, the user may input the open password. When the password inputted by the user does not conform to a preset password format, a prompt that the password inputted by the user is incorrect is issued, the previously received password inputted by the user is cleared, and the input box for the open password is reset to make the user input an open password again. Further, the number of continuously inputting incorrect open passwords by the user may be also recorded. When the number is greater than a preset end threshold, the current step of opening a wifi setting page ends and it is returned to the home page.

In step 309, password data locally stored is called to verify the open password inputted by the user. Step 310 is performed, if the verification is successful; or step 311 is performed, if the verification is not successful.

After the open password inputted by the user is received, local password data in the storage firmware is called, and the open password inputted by the user is compared with the local password data. If the open password is identical to the local password data, the verification is successful. If the open password is not identical to the local password data, the verification is not successful.

In step 310, a wifi setting page is opened.

In step 311, the wifi setting page is not opened, and it is returned to the home page directly.

In step 312, a network connection is established according to setting Information inputted by the user on the wifi setting page.

In step 313, an unlocking password inputted by the user is received and the unlocking password is uploaded to a server for verification through wifi.

In step 314, the mobile terminal in the loss lock state is unlocked, if the verification is successful.

As can be seen from the embodiment, the determination of the display condition for the wifi open button is set, the verification of the open password before opening the wifi setting page is set. The unlocking method according to the disclosure can be implemented by the owner, thereby further enhancing the security of the mobile terminal in the loss lock state.

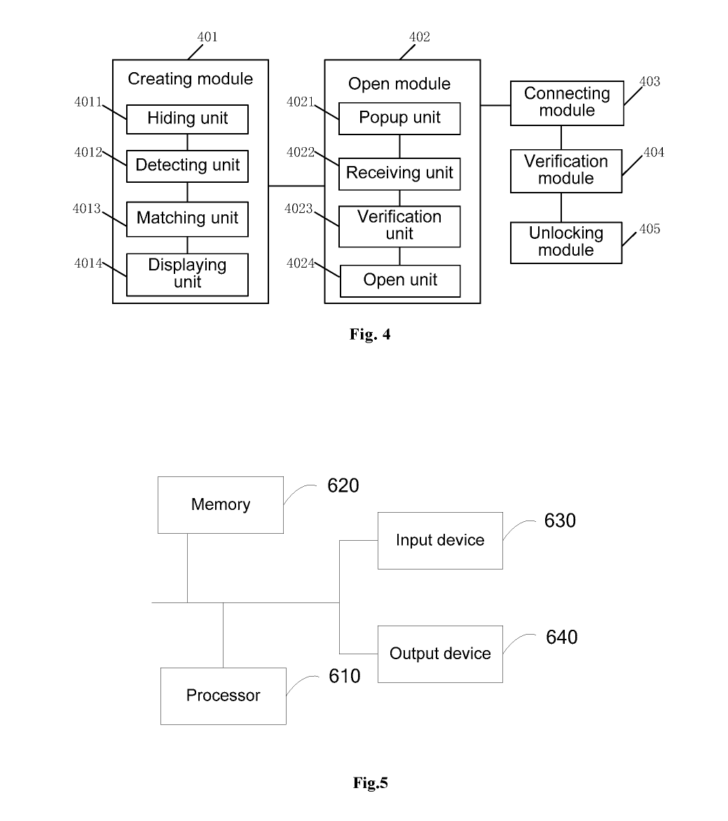

In another aspect, an apparatus for unlocking a mobile terminal in a loss lock state is further provided according to an embodiment of the present disclosure. FIG. 4 is a schematic structural diagram of an apparatus for unlocking a mobile terminal in a loss lock state according to an embodiment of the present disclosure.

The apparatus for unlocking a mobile terminal in a loss lock state includes a creating module 401, an open module 402, a connecting module 403, a verification module 404 and an unlocking module 405.

The creating module 401 is configured for creating a wifi open button on a home page of the mobile terminal in the loss lock state.

The open module 402 is configured for receiving a triggering instruction of a user for the wifi open button and opening a wifi setting page.

The connecting module 403 is configured for establishing a network connection according to setting Information inputted by the user on the wifi setting page.

The verification module 404 is configured for receiving an unlocking password inputted by the user and uploading the unlocking password to a server for verification through wifi.

The unlocking module 405 is configured for unlocking the mobile terminal in the loss lock state, if the verification is successful.

Preferably, the creating module 401 further includes a hiding unit 4011, a detecting unit 4012, a matching unit 4013 and a displaying unit 4014.

The hiding unit 4011 is configured for hiding the wifi open button.

The detecting unit 4012 is configured for detecting a touch event inputted by the user.

The matching unit 4013 is configured for matching the touch event with a preset display condition.

The displaying unit 4014 is configured for displaying the wifi open button, if the matching is successful.

The display condition may be a preset sliding trajectory. Accordingly, the detecting unit 4012 is further configured for detecting a sliding touch event inputted by the user and recording a sliding trajectory of the sliding touch event; and the matching unit 4013 is further configured for determining whether the sliding trajectory is identical to the preset sliding trajectory.

Optionally, the display condition may also be a preset duration of heavy press or light press. Accordingly, the detecting unit 4012 is further configured for detecting a heavy press or light press touch event inputted by the user and recording a duration of the heavy press or light press touch event; and the matching unit 4013 is further configured for determining whether the duration is greater than or equal to the preset duration.

Furthermore, in the embodiment, the open module 402 further includes a popup unit 4021, a receiving unit 4022, a verification unit 4023 and an open unit 4024.

The popup unit 4021 is configured for popping up an input box for an open password.

The receiving unit 4022 is configured for receiving the open password inputted by the user.

The verification unit 4023 is configured for calling password data locally stored to verify the open password inputted by the user.

The open unit 4024 is configured for opening the wifi setting page, if the verification is successful; or returning to the home page of the mobile terminal in the loss lock state, if the verification is not successful.

Embodiments of the present disclosure further provide a non-volatile computer-readable storage medium, the non-volatile computer-readable storage medium is stored with computer executable instructions which are configured to perform any of the embodiments described above of the method for unlocking a mobile terminal in a loss lock state.

FIG. 5 is a schematic structure diagram of hardware of an electronic device for unlocking a mobile terminal in a loss lock state according to an embodiment of the present disclosure. As shown in FIG. 5, the device includes one or more processors 610 and a memory 620, and FIG. 5 illustrates one processor 610 as an example.

The electronic device for unlocking a mobile terminal in a loss lock state may further include an input device 630 and an output device 640.

The processor 610, memory 620, input device 630 and output device 640 may be connected with each other through bus or other ways. FIG. 5 illustrates bus connection as an example.

As a non-volatile computer readable storage medium, the memory 620 may be configured to store non-volatile software program, non-volatile computer executable program and module, such as program instruction/module (for example, the creating module 401, the open module 402, the connecting module 403, the verification module 404 and the unlocking module 405 shown in FIG. 4) corresponding to the method for unlocking a mobile terminal in a loss lock state according to the embodiments of the disclosure. By executing the non-volatile software program, instruction and module stored in the memory 620, the processor 610 may perform various functional applications of the server and data processing, that is, achieve the method for unlocking a mobile terminal in a loss lock state according to the above mentioned embodiments.

The memory 620 may include a program storage area and a data storage area, wherein the program storage area may store the operating system and application which are needed by at least one function, and the data storage area may store data which is created according to use of the device for unlocking a mobile terminal in a loss lock state, and the like. Further, the memory 620 may include a high-speed random access memory, and may further include a non-volatile memory, such as at least one of disk memory device, flash memory device or other types of non-volatile solid state memory device. In some embodiments, optionally, the memory 620 may include a memory provided remotely with respect to the processor 610, and such memory may be connected with the device for unlocking a mobile terminal in a loss lock state through network. The examples of the network may include but not limited to Internet, intranet, LAN (Local Area Network), mobile communication network and combinations thereof.

The input device 630 may receive inputted digital or character information, and generate key signal input related to the user settings and functional control of the device for unlocking a mobile terminal in a loss lock state. The output device 640 may include a display device such as a display screen and the like.

The above one or more modules may be stored in the memory 620. When these modules are executed by the one or more processor 610, the method for unlocking a mobile terminal in a loss lock state according to any one of the above embodiments may be performed.

The above product may perform the methods provided in the embodiments of the disclosure, and include functional modules corresponding to these methods and advantageous effects. Further technical details which are not described in detail in the present embodiment may refer to the methods provided according to embodiments of the disclosure.

The electronic device in the embodiment of the present disclosure may be embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID, UMPC devices and the like, such as iPad;

(3) portable entertainment device, which can display and play multimedia contents, and includes audio or video player (such as iPod), portable game console, e-book and smart toys and portable vehicle navigation device;

(4) server, which is an device for providing computing service, and constituted by processor, hard disc, memory, system bus and the like, wherein the server has a framework similar to that of a computer, but is demanded for superior processing ability, stability, reliability, security, extendibility and manageability due to high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in a place or distributed to a plurality of network units. All or part of modules may be selected as actually required to implement the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk, compact disc and the like, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for unlocking a mobile terminal in a loss lock state, which is applied to the mobile terminal, comprising:
creating a wifi open button on a home page of the mobile terminal in the loss lock state;
receiving a triggering instruction of a user for the wifi open button and opening a wifi setting page;
establishing a network connection according to setting information inputted by the user on the wifi setting page;
receiving an unlocking password inputted by the user and uploading the unlocking password to a server for verification through wifi; and
unlocking the mobile terminal in the loss lock state, if the verification is successful.

2. The method according to claim 1, wherein after the creating a wifi open button, the method further comprises:
hiding the wifi open button;
detecting a touch event inputted by the user;
matching the touch event with a preset display condition; and
displaying the wifi open button, if the matching is successful.

3. The method according to claim 2, wherein the display condition is a preset sliding trajectory;
the step of detecting a touch event inputted by the user comprises: detecting a sliding touch event inputted by the user and recording a sliding trajectory of the sliding touch event; and
the step of matching the touch event with a preset display condition comprises: determining whether the sliding trajectory is identical to the preset sliding trajectory.

4. The method according to claim 2, wherein the display condition is a preset duration of heavy press or light press;
the step of detecting a touch event inputted by the user comprises: detecting a heavy press or light press touch event inputted by the user and recording a duration of the heavy press or light press touch event; and
the step of matching the touch event with a preset display condition comprises: determining whether the duration is greater than or equal to the preset duration.

5. The method according to claim 1, wherein after the receiving a selecting instruction of a user for the wifi open button, the method further comprises:
popping up an input box for an open password;
receiving the open password inputted by the user;
calling password data locally stored to verify the open password inputted by the user;
opening the wifi setting page, if verification is successful, or returning to the home page of the mobile terminal in the loss lock state, if the verification is not successful.

6. A non-transitory computer-readable storage medium storing computer executable instructions which are configured to:
create a wifi open button on a home page of the mobile terminal in the loss lock state;
receive a triggering instruction of a user for the wifi open button and open a wifi setting page;
establish a network connection according to setting information inputted by the user on the wifi setting page;
receive an unlocking password inputted by the user and upload the unlocking password to a server for verification through wifi; and
unlock the mobile terminal in the loss lock state, if the verification is successful.

7. The non-transitory computer-readable storage medium according to claim 6, wherein after a wifi open button is created, the computer executable instructions are further configured to:
hide the wifi open button;
detect a touch event inputted by the user;
match the touch event with a preset display condition; and
display the wifi open button, if the matching is successful.

8. The non-transitory computer-readable storage medium according to claim 7, wherein the display condition is a preset sliding trajectory;
the step of detecting a touch event inputted by the user comprises: detecting a sliding touch event inputted by the user and recording a sliding trajectory of the sliding touch event; and
the step of matching the touch event with a preset display condition comprises: determining whether the sliding trajectory is identical to the preset sliding trajectory.

9. The non-transitory computer-readable storage medium according to claim 7, wherein the display condition is a preset duration of heavy press or light press;
the step of detecting a touch event inputted by the user comprises: detecting a heavy press or light press touch event inputted by the user and recording a duration of the heavy press or light press touch event; and
the step of matching the touch event with a preset display condition comprises: determining whether the duration is greater than or equal to the preset duration.

10. The non-transitory computer-readable storage medium according to claim 6, wherein after a selecting instruction of a user for the wifi open button is received, the computer executable instructions are further configured to:
pop up an input box for an open password;
receive the open password inputted by the user;
call password data locally stored to verify the open password inputted by the user;
open the wifi setting page, if verification is successful, or return to the home page of the mobile terminal in the loss lock state, if the verification is not successful.

11. An electronic device, comprising:
at least one processor; and
a memory communicably connected with the at least one processor,
wherein the memory is stored with instructions executable by the at least one processor, and the instructions are executed by the at least one processor to cause the at least one processor to:
create a wifi open button on a home page of the mobile terminal in the loss lock state;
receive a triggering instruction of a user for the wifi open button and open a wifi setting page;
establish a network connection according to setting information inputted by the user on the wifi setting page;
receive an unlocking password inputted by the user and upload the unlocking password to a server for verification through wifi; and
unlock the mobile terminal in the loss lock state, if the verification is successful.

12. The electronic device according to claim 11, wherein after a wifi open button is created, the at least one processor is further caused to:
hide the wifi open button;
detect a touch event inputted by the user;
match the touch event with a preset display condition; and
display the wifi open button, if the matching is successful.

13. The electronic device according to claim 12, wherein the display condition is a preset sliding trajectory;
the step of detecting a touch event inputted by the user comprises: detecting a sliding touch event inputted by the user and recording a sliding trajectory of the sliding touch event; and
the step of matching the touch event with a preset display condition comprises: determining whether the sliding trajectory is identical to the preset sliding trajectory.

14. The electronic device according to claim 12, wherein the display condition is a preset duration of heavy press or light press;
the step of detecting a touch event inputted by the user comprises: detecting a heavy press or light press touch event inputted by the user and recording a duration of the heavy press or light press touch event; and
the step of matching the touch event with a preset display condition comprises: determining whether the duration is greater than or equal to the preset duration.

15. The electronic device according to claim 11, wherein after a selecting instruction of a user for the wifi open button is received, the at least one processor is further caused to:
pop up an input box for an open password;
receive the open password inputted by the user;
call password data locally stored to verify the open password inputted by the user;
open the wifi setting page, if verification is successful, or return to the home page of the mobile terminal in the loss lock state, if the verification is not successful.
